(19) United States
(12) Patent Application Publication
(10) Pub. No.: US 2014/0343841 A1
(43) Pub. Date: Nov. 20, 2014

(54) PROVIDING PREDICTED TRAVEL INFORMATION

(71) Applicant: Google Inc., Mountain View, CA (US)

(72) Inventors: Alexander Faaborg, Mountain View, CA (US); Gokay Baris Gultekin, Palo Alto, CA (US); Rachel Leah Garb, San Francisco, CA (US); Andrew Theodore Wansley, San Francisco, CA (US)

(73) Assignee: Google Inc., Mountain View, CA (US)

(21) Appl. No.: 14/055,666

(22) Filed: Oct. 16, 2013

Related U.S. Application Data
(60) Provisional application No. 61/823,206, filed on May 14, 2013.

(51) Int. Cl. G01C 21/26

(52) U.S. Cl. CPC G01C 21/26
USPC 701/465

(57) ABSTRACT

A computing system includes at least one processor and at least one module operable by the at least one processor to receive location information associated with a computing device, including indications of locations at which the computing device was previously located and an indication of a current location of the computing device, determine, based at least in part on the location information, a predicted destination, determine, based at least in part on the current location of the computing device and the predicted destination, a predicted travel route, determine, based at least in part on an amount of traffic along the predicted travel route, a predicted arrival time, determine, based at least in part on the predicted destination, one or more other users, and send an indication of the predicted arrival time to one or more computing devices associated with the one or more other users.

This application claims the benefit of U.S. Provisional Application No. 61/823,206, filed May 14, 2013, the entire content of which is incorporated by reference herein.

### BACKGROUND

Some computing devices (e.g., mobile phones, tablet computers, etc.) can output travel routes and navigation directions. In some cases, a portion of the information included in the output travel routes and navigation directions can be received, by the computing device, from one or more other computing systems and/or devices (e.g., a network-based server device or system). The navigation directions may enable a user of a computing device to view travel routes and navigate to a destination via various modes of transportation (e.g., car, public transit, or walking). For instance, a computing device may receive an indication of a destination from a user and output navigation directions to that destination.

The computing device may have access to location information, traffic information, or other information and may be operable to provide additional information to the user, such as a predicted time of arrival of the user at a destination, alternate routes to the destination, or other travel information. Users, however, may be unable to exploit such navigation instructions or predictions in certain situations (e.g., while in transit). For example, the computing device may provide a user of the computing device with a prediction of the user's arrival time at the specified destination and may update the prediction as the user is traveling to the destination. However, if the user is driving an automobile, or otherwise unable to use the computing device, it may be difficult and/or unsafe for the user to inform other users of his or her current location or any delays or changes in arrival time.

### SUMMARY

In one example, a method includes receiving, by a computing system, location information associated with a computing device, wherein the location information includes a plurality of indications of locations at which the computing device was previously located and an indication of a current location of the computing device, and wherein the computing device is associated with a user, determining, by the computing system and based at least in part on the location information, a predicted destination of the user, and determining, by the computing system and based at least in part on the current location of the computing device and the predicted destination, a predicted travel route of the user to the predicted destination. The method may further include determining, by the computing system and based at least in part on an amount of traffic along the predicted travel route, a predicted arrival time of the user at the predicted destination, determining, by the computing system and based at least in part on the predicted destination, one or more other users associated with the user, and sending, by the computing system and to one or more computing devices associated with the one or more other users, an indication of the predicted arrival time of the user.

In another example, a computing system includes at least one processor and at least one module operable by the at least one processor to receive location information associated with a computing device, wherein the location information includes a plurality of indications of locations at which the computing device was previously located and an indication of a current location of the computing device, and wherein the computing device is associated with a user, determine, based at least in part on the location information, a predicted destination of the user, and determine, based at least in part on the current location of the computing device and the predicted destination, a predicted travel route of the user to the predicted destination. The at least one module may be further operable by the at least one processor to determine, based at least in part on an amount of traffic along the predicted travel route, a predicted arrival time of the user at the predicted destination, determine, based at least in part on the predicted destination, one or more other users associated with the predicted destination, and send, to one or more computing devices associated with the one or more other users, an indication of the predicted arrival time of the user.

In another example, a computer-readable storage medium is encoded with instructions that, when executed, cause at least one processor of a computing device to receive location information associated with a computing device, wherein the location information includes a plurality of indications of locations at which the computing device was previously located and an indication of a current location of the computing device, and wherein the computing device is associated with a user, determine, based at least in part on the location information, a predicted destination of the user, and determine, based at least in part on the current location of the computing device and the predicted destination, a predicted travel route of the user to the predicted destination. The computer-readable storage medium may be further encoded with instructions that, when executed, cause the at least one processor of the computing device to determine, based at least in part on the predicted travel route, a predicted arrival time of the user at the predicted destination, determine, based at least in part on based on previous communications of the user, one or more other users associated with the previous communications, and send, to one or more computing devices associated with the one or more other users, an indication of the predicted arrival time of the user.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example computing environment and graphical user interface (GUI) for providing other users with predicted travel information, in accordance with one or more aspects of the present disclosure.

FIG. 2 is a block diagram illustrating one example of a coordination unit for providing other users with predicted travel information, in accordance with one or more aspects of the present disclosure.

FIGS. 3A and 3B are conceptual diagrams illustrating example GUIs for providing other users with predicted travel information, in accordance with one or more aspects of the present disclosure.

FIGS. 4A and 4B are conceptual diagrams illustrating example location information for providing other users with predicted travel information, in accordance with one or more aspects of the present disclosure.

FIG. 5 is a flow diagram illustrating example operations for providing other users with predicted travel information, in accordance with one or more aspects of the present disclosure.

### DETAILED DESCRIPTION

Techniques of the present disclosure may enable a computing system to determine predicted travel information for a user and send the predicted travel information to computing devices associated with one or more other users. For example, a computing system may receive location information associated with a computing device. The location information may include a plurality of indications of locations at which the computing device was previously located and an indication of a current location of the computing device. The computing system may determine a predicted destination of the user based at least in part on the received location information. For instance, the computing system may determine that the user is traveling from work to home. Based at least in part on the current location of the computing device and a predicted destination (e.g., home), the computing system may determine a predicted travel route from the current location to the predicted destination.

Based on an amount of traffic along the predicted travel route, the computing system may determine a predicted arrival time of the user at the predicted destination. The computing system may also determine one or more other users (e.g., close friends of the user, family members of the user, housemates of the user, etc.) associated with the predicted destination. The computing system may automatically send an indication of the predicted arrival time of the user to one or more computing devices associated with the other users. Moreover, if the computing system determines that there is a change in the traffic conditions along the predicted travel route, a change in the predicted destination, a change in the predicted travel route, or any other change associated with the user's travel, the computing system may update the predicted arrival time of the user and may identify a different set of computing devices associated with different other users and automatically send an indication of the updated predicted arrival time of the user to the different set of computing devices associated with the different other users.

In this manner, techniques of this disclosure may enable a user to automatically provide one or more other users with his or her travel status without the user having to manually relay travel information. That is, techniques of the present disclosure may allow the user to easily share relevant information with other users by predicting travel information or other contextual information for the user, and proactively providing the predicted information to the other users. Consequently, the user may be able to relay predicted travel information to the other users without the user losing focus on other activities such as driving, catching a bus, or paying attention in a meeting. Additionally, techniques of the present disclosure may enable the user to provide more accurate social network status messages, thereby ensuring that other users are aware of the user's current status, such as what the user is doing, where the user is going, whether the user is available, and if unavailable, when the user may become available.

In general, a computing device of a user may send location information to the computing system only if the computing device receives permission from the user to send the location information. For example, in situations discussed below in which the computing device may collect, transmit, or may make use of personal information about a user (e.g., previous locations) the user may be provided with an opportunity to control whether programs or features of the computing device can collect user information (e.g., information about a user's previous locations, a user's social network, a user's social actions or activities, a user's profession, a user's preferences, or a user's current location), or to control whether and/or how the computing device may store and share user information.

In addition, certain data may be treated in one or more ways before it is stored, transmitted, or used by the computing device so that personally identifiable information is removed. For example, a user's identity may be treated so that no personally identifiable information can be determined about the user, or a user's geographic location may be generalized where location information is obtained (such as to a city, ZIP code, or state level), so that a particular location of the user cannot be determined. Thus, the user may have control over how information is collected about the user and stored, transmitted, and/or used by the computing device. Furthermore, in some examples, computing devices of the other users may only receive, utilize, and/or display the received information if the computing devices receive permission from the respective other users to receive, utilize, and/or display the predicted travel information.

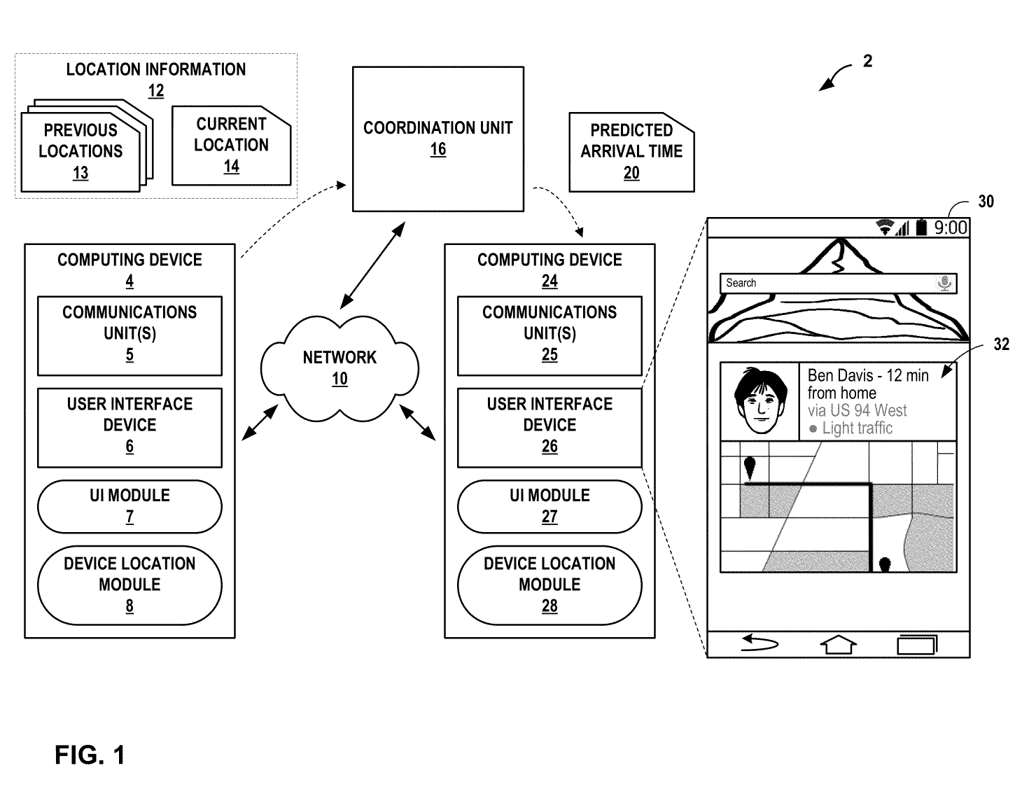

FIG. 1 is a block diagram illustrating an example computing environment 2 and graphical user interface (GUI) 30 for providing other users with predicted travel information, in accordance with one or more aspects of the present disclosure. As shown in FIG. 1, computing environment 2 includes computing device 4, network 10, coordination unit 16, and computing device 24. Examples of computing devices 4 and 24 may include, but are not limited to, portable, mobile, or other devices, such as mobile phones (including smartphones), laptop computers, desktop computers, tablet computers, smart television platforms, personal digital assistants (PDAs), server computers, mainframes, and the like. For instance, in the example of FIG. 1, each of computing devices 4 and 24 may be a smartphone.

Computing device 4, as shown in FIG. 1, includes one or more communications units 5. Computing device 4, in one example, utilizes communication units 5 to communicate with external devices via one or more networks, such as one or more wireless networks. Communication units 5 may include a network interface card, such as an Ethernet card, an optical transceiver, a radio frequency transceiver, or any other type of device that can send and receive information. Other examples of such network interfaces may include Bluetooth, 3G and WiFi radio components as well as Universal Serial Bus (USB). In some examples, computing device 4 may utilize communication units 5 to communicate, via network 10, with coordination unit 16, computing device 24, or other computing devices. For instance, one or more components of computing device 4 may send data to communications units 5 for transmission to coordination unit 16 via network 10.

In the example of FIG. 1, computing device 4 includes user interface (UI) device 6. UI device 6 of computing device 4 may function as an input device for computing device 4 and as an output device. UI device 6 may be implemented using various technologies. For instance, UI device 6 may function as an input device using a presence-sensitive input screen, such as a resistive touchscreen, a surface acoustic wave touchscreen, a capacitive touchscreen, a projective capacitance touchscreen, a pressure sensitive screen, an acoustic pulse recognition touchscreen, or another presence-sensitive screen technology. UI device 6 of computing device 4 may include a presence-sensitive screen that may receive tactile input from a user of computing device 4. UI device 6 may receive indications of the tactile input by detecting one or more gestures from the user (e.g., when the user touches or points to one or more locations of UI device 4 with a finger or a stylus pen).

UI device 6 may function as an output (e.g., display) device using any of one or more display devices, such as a liquid crystal display (LCD), dot matrix display, light emitting diode (LED) display, organic light-emitting diode (OLED) display, e-ink, or similar monochrome or color display capable of outputting visible information to a user of computing device 4. For instance, UI device 6 may present output to a user of computing device 4 at a presence-sensitive screen. UI device 6 may present the output as a graphical user interface which may be associated with functionality provided by computing device 4. For example, UI device 6 may present various user interfaces of applications executing at or accessible by computing device 4 (e.g., an electronic message application, an Internet browser application, etc.). A user of computing device 4 may interact with a respective user interface of an application to cause computing device 4 to perform operations relating to a function.

In the example of FIG. 1, computing device 4 includes user interface (UI) module 7 and device location module 8. Modules 7 and 8 may perform operations described using hardware, software, firmware, or a mixture of hardware, software, and firmware residing in and/or executing at computing device 4. Computing device 4 may execute modules 7 and 8 with one processor or with multiple processors. In some examples, computing device 4 may execute modules 7 and 8 as a virtual machine executing on underlying hardware. Modules 7 and 8 may execute as a service of an operating system or computing platform or may execute as one or more executable programs at an application layer of a computing platform.

UI module 7 may be operable (e.g., by one or more processors of computing device 4) to receive input from UI device 6. For instance, UI module 7 may receive one or more indications of user input performed at UI device 6. Responsive to receiving an indication of user input, UI module 7 may provide data, based on the received indication, to one or more other components of computing device 4 (e.g., modules 7, 8). UI module 7 may be operable to provide UI device 6 with output for display. For instance, UI module 7 may receive data for display from one or more other components of computing device 4 (e.g., modules 7, 8). Responsive to receiving data for display, UI module 7 may cause UI device 6 to display one or more graphical user interfaces. That is, UI module 5 may, in some examples, enable one or more components of computing device 4 to communicate with UI device 6, receive user input performed at UI device 6, and/or provide output to a user at UI device 6.

Device location module 8 may be operable (e.g., by one or more processors of computing device 4) to determine a current location of computing device 4 and a current time. For example, computing device 4 may include a global positioning system (GPS) radio (not shown) for receiving GPS signals (e.g., from a GPS satellite). Device location module 8 may analyze the GPS signals received by the GPS radio and determine the current location of computing device 4 and the current time. Computing device 4 may include other radios or sensor devices (e.g., cellular radio, Wi-Fi radio, etc.) capable of receiving signal data from which device location module 8 can determine the current location of computing device 4 and the current time. In some examples, device location module 8 may determine location information as coordinate (e.g., GPS) location information. In other examples, device location module 8 may determine location information as one or more general or relative locations, such as an address, a place, a country, a city, a type of building (e.g., a library, an airport, etc.).

Computing device 4 may determine a current location of computing device 4 and a current time only if computing device 4 receives permission from the user to determine the information. Additionally, computing device 4 may transmit location information 12 only if computing device 4 receives permission from the user to share location information (e.g., with a contact). That is, in situations in which computing device 4 may collect, data mine, analyze and/or otherwise make use of personal information about the user, the user may be provided with an opportunity to control whether programs or features of computing device 4 can collect user information (e.g., previous communications, information about a user's email, a user's social network, social actions or activities, a user's preferences, a user's current location, or a user's past locations). The user may also be provided with an opportunity to control whether and how computing device 4 may transmit such user information. In addition, certain data may be treated in one or more ways before it is stored, transmitted, or used by computing device 4, so that personally identifiable information is removed. Thus, the user of computing device 4 may have control over how information is collected about the user and used by computing device 4.

Device location module 8 may, in some examples, output location and time data to one or more other components of computing device 4, such as communications units 5. In other examples, device location module 8 or other components of computing device 4 may store data indicating one or more determined current locations of computing device 4 and current times, such as in a database. Computing device 4 may cause communications units 5 to transmit the stored data. That is, computing device 4 may immediately transmit the determined current location and current time, or may store one or more determined current locations and current times (e.g., as determined previous locations and previous times), and transmit the stored information at a later time. In any case, communications units 5 may receive one or more locations and times from other components of computing device 4 and transmit the received data via network 10.

As shown in the example of FIG. 1, communications units 5 may transmit location information 12 to coordination unit 16 (e.g., via network 10). Location information 12 may contain one or more previous locations 13 as well as current location 14 (e.g., a current location of computing device 4). Previous locations 13 may include previous locations of computing device 4 and associated previous times at which computing device 4 was determined to be at the previous locations, such as those previously determined by device location module 8 and stored in a database of computing device 4. Current location 14 may include a current location of computing device 4 and a current time. In some examples, computing device 4 may send location information 12 in response to input from a user of computing device 4, such as when the user chooses to run a maps application. In other examples, computing device 4 may send location information 12 automatically, such as at a certain time of day, or when computing device 4 has been idle for a certain amount of time. For instance, computing device 4 may periodically determine a current location and current time, and store the determined information (e.g., as current location 14). When a new current location and current time are determined, the previous current location and current time may be stored by computing device 4 (e.g., as part of previous locations 13). Subsequently, responsive to a certain event or trigger, computing device 4 may transmit location information 12.

In some examples, computing device 4 may also transmit permission data to coordination unit 16. Permission data may be generated in response to a user interacting with computing device 4, and may be transferred prior to, in conjunction with, or subsequent to location information 12. Permission data may include information identifying one or more other users or social network services that are authorized to receive location information or information based on location information. Permission data may identify other users or social network services in various ways, such as using a telephone number of another user, a specific user identifier (UID) assigned to the other user, a social network account of the other user, a social network service indication, or other identifying methods. In other words, the user of computing device 4 may cause computing device 4 to generate permission data defining one or more other users and/or one or more social network services to which coordination unit 16 may send location information received from computing device 4 and/or derivative information based on the received location information.

In some examples, permission data may be transient or associated with a particular set of location information. For instance, the user of computing device 4 may interact with computing device 4 to specify another user or a social network service that is authorized to receive location information 12 or derivative data. That is, the user may specify other users and/or social network services that are authorized to receive travel information for the current trip or current instance but are not authorized to receive travel information for future trips or future instances. In other examples, permission data may be more persistent. For instance, permission data may specify other users or social network services that are allowed to receive all subsequent location information or derivative data, unless a revocation is received. That is, the user may specify other users and/or social network services that are authorized to receive travel information for some or all subsequent trips or instances, unless and until the user revokes the authorization. Other users authorized to receive predicted travel information for a user may be required to explicitly authorize coordination unit 16 to provide the predicted travel information. That is, coordination unit 16 may not provide predicted travel information for one user (e.g., the traveling user) to another user (e.g., the receiving user) unless both the traveling user and the receiving user provide explicit permission to coordination unit 16.

As shown in the example of FIG. 1, coordination unit 16 may receive location information 12 from computing device 4 (e.g., via network 10). Though not shown in FIG. 1, coordination unit 16 may also receive permission data. In accordance with one or more techniques of the present disclosure, coordination unit 16 may determine a predicted destination based at least in part on location information 12. The predicted destination may represent an expected travel destination of the user of computing device 4. For instance, coordination unit 16 may analyze received location information 12 and determine an address, geographical coordinates, or other information defining a specific location to which it is statistically likely that computing device 4 will be traveling in the near future (e.g., within 10 minutes, within an hour, within 3 hours, or other time frame). In some examples, coordination unit 16 may determine that it is unlikely that computing device 4 will be traveling at all. In such instance, coordination unit 16 may do nothing, or perform one or more other operations unrelated to the present disclosure. That is, coordination unit 16 may be configured to send an indication of travel to other users during relevant travel times and be configured to refrain from sending the indication of travel at other times.

Responsive to determining a predicted destination, coordination unit 16 may determine a predicted travel route of the user of computing device 4. The predicted travel route may be determined based at least in part on the predicted destination and current location 14. For instance, coordination unit 16 may determine one or more paths (e.g., roads, highways, interstates, bus routes, subway lines, train tracks, walking trails, or other paths), which the user of computing device 4 may use in order to travel from the location indicated by current location 14 to the predicted destination.

Coordination unit 16 may determine a predicted arrival time of the user of computing device 4 at the predicted destination, based at least in part on an amount of traffic along the predicted travel route. That is, coordination unit 16 may store or otherwise have access to traffic information, and may make use of the traffic information to determine a prediction of how long it will take the user of computing device 4 to travel from the location indicated by current location 14 to the determined predicted destination. In some examples, the predicted arrival time may be a specific time, such as 2:34 PM Eastern Standard Time. In other examples, the predicted arrival time may be a specific time duration (e.g., 10 minutes and 30 seconds, 45 minutes, 2 hours and 15 minutes, etc.).

Coordination unit 16 may determine, based at least in part on the predicted destination, one or more other users associated with the predicted destination. For instance, coordination unit 16 may determine another user (e.g., a housemate or family member of the user of computing device 4) that is currently located at the predicted destination. In some examples, coordination unit 16 may determine the other user's location based on location information received from a computing device associated with the other user (e.g., computing device 24). Coordination unit 16 may only receive location information from computing device 24 if the user of computing device 24 has explicitly allowed computing device 24 to provide such information.

In some examples, coordination unit 16 may determine users to whom to send predicted travel information based on other information, including other information received from computing device 4 or other information received from computing device 24. For instance, coordination unit 16 may determine users to whom to send predicted travel information based at least in part on permission data received from computing device 4. That is, in some examples, coordination unit 16 may base its determination of other users associated with the predicted destination on the permission data received from computing device 4, location information received from other users, other data, or various combinations thereof. Coordination unit 16 may send an indication of the predicted arrival time (e.g., predicted arrival time 20) to the one or more other users associated with the predicted destination (e.g., computing device 24).

As shown in the example of FIG. 1, computing device 24 includes communications units 25, user interface (UI) device 26, user interface (UI) module 27, and device location module 28. In some examples, communications units 25, UI device 26, and modules 27 and 28 of computing device 24 may be the same or similar to communications units 5, UI device 6, and modules 7 and 8 of computing device 4, respectively. In other examples, communications units 25, UI device 26, and/or modules 27 and 28 may have additional or different functionality than communications units 5, UI device 6, and modules 7 and 8 of computing device 4.

Computing device 24, as shown in the example of FIG. 1, may receive predicted arrival time 20 (e.g., via network 10). Predicted arrival time 20 may include an indication of a user (e.g., the user of computing device 4), an indication of the predicted destination of the user, and at least one of a time indicating when the user is predicted to arrive at the predicted destination and a time period indicating the duration of time until the user is predicted to arrive at the predicted destination. In some examples, predicted arrival time 20 may also include a current location of the user (e.g., current location 14).

Communications units 25 of computing device 24 may receive predicted arrival time 20 and may provide at least a portion of the received data to one or more other components of computing device 24. For instance, communication units 25 may send the data to one or more applications installed at computing device 24. Based on the data received, the applications or other components may send graphical information to UI module 27 for display at UI device 26. Consequently, UI module 27 of computing device 24 may cause UI device 26 to display GUI 30.

GUI 30, as shown in the example of FIG. 1, includes graphical indications (e.g., elements) displayed at various locations of UI device 26. FIG. 1 illustrates card 32 as one example graphical indication within GUI 30. Card 30 includes information from predicted arrival time 20, such as a name of a user of computing device 4, “Ben Davis,” the predicted arrival time of the user of computing device 4, “12 min,” and the predicted destination of the user of computing device 4, “home.” By displaying card 32, computing device 24 may allow a user of computing device 24 to view predicted travel information for the user of computing device 4, without requiring the user of computing device 4 to send updates. That is, in one aspect of the present disclosure, coordination unit 16 may enable one or more computing devices of one or more other users to provide predicted travel information for a traveling user as informational cards, notifications, or other graphical elements.

Computing device 24 may be operable to utilize and/or display predicted arrival time 20 in other ways, such as providing one or more notifications (e.g., graphical notifications, audible notifications, or other notification) to the user of computing device 24 regarding the predicted travel of the user of computing device 4. In some examples, computing device 24 may be operable to update a social network status message of the user of computing device 4. For instance, computing device 24 may be a server for a social network service. In accordance with one or more techniques of the present disclosure, computing device 24 may receive predicted arrival time 20 and update the social network status message of a user account associated with the user of computing device 4. Consequently, other users who access the social network service (e.g., via other computing devices not shown in FIG. 1), may view the updated social network status message. In other words, coordination unit 16 may provide predicted travel information to other users by updating a social network status message or chat status message of the traveling user. In this way, coordination unit 16 may reduce the amount of effort involved in manually providing such information. By updating status messages of a user based on the user's current context, coordination unit 16 may reduce the likelihood that the status messages remain out of date for long periods of time. For instance, in viewing the updated status messages, other users may be able to learn where the user is, whether the user is available, what the user is doing, and/or when the user may be available in the future.

By predicting travel information for a user and providing it to other users and/or updating a social network status message of the user, coordination system 16 may enable other computing devices to display (e.g., as cards, notifications, or the like) how much time it will take for the user to arrive. Coordination unit 16 may output predicted travel information (e.g., for display) for a traveling user when the user is traveling or about to travel to work, to home, or to other destinations such as the gym or a restaurant or bar. In some examples, coordination unit 16 may only display predicted travel information to other users that are currently at the user's predicted destination, or to other users currently traveling to the user's predicted destination (e.g., a joint predicted destination). When coordination unit 16 determines that a received indication of a location of the user corresponds to the predicted destination of the user, coordination unit 16 may determine that the user has arrived at their destination. Consequently, coordination unit 16 may send data that causes one or more computing devices of the other users to display an interruptive notification. The interruptive notification, in some examples, may only be sent to those users who have not yet arrived at the joint predicted destination. In some examples, such as where coordination unit 16 determines a joint predicted destination, coordination unit 16 may cause one or more computing devices of the other users to display an interruptive notification informing the other user (or users) when, based on current traffic, he or she should leave their own location to meet the first user at the joint predicted destination.

By automatically providing predicted travel information to social network services or chat services as status message updates, coordination unit 16 may reduce the effort required for a user to update his or her status message on a social network account or chat service. In some examples, automatic status message updates sent by coordination unit 16 may be limited (e.g., by using the permission data received from computing device 4) to specific social network contacts of the user, thereby allowing close friends and family to easily determine the user's availability, while avoiding providing personal information to casual acquaintances. That is, coordination unit 16 may enable the user to specify which other users are able to receive these types of status messages. Consequently, coordination unit 16 may enable different treatment of chat contacts and/or social network contacts, such as not changing status messages for acquaintances while updating the user's status message for friends and family.

By determining a predicted destination only for travel that is likely to happen in the near future, coordination unit 16 may cause one or more computing devices or social network services to display predicted travel information during the user's travel time or “commute window.” That is, in some examples, predicted travel information may be displayed proactively and contextually when it is the most relevant (e.g., based on the analysis of location information 12). In other examples, predicted travel information for the user may be displayed on-demand, such as in response to a voice command (e.g., resulting in an audio indication of predicted arrival time) or other input by the other users. In other words, techniques of the present disclosure may reduce or eliminate the sending and/or receipt of messages asking a user when he or she is going to arrive at a particular location, if he or she has left yet, what route he or she is taking, and the like. Instead, coordination unit 16 may share this information with the correct set of users without forcing users to constantly or manually relay it to one another.

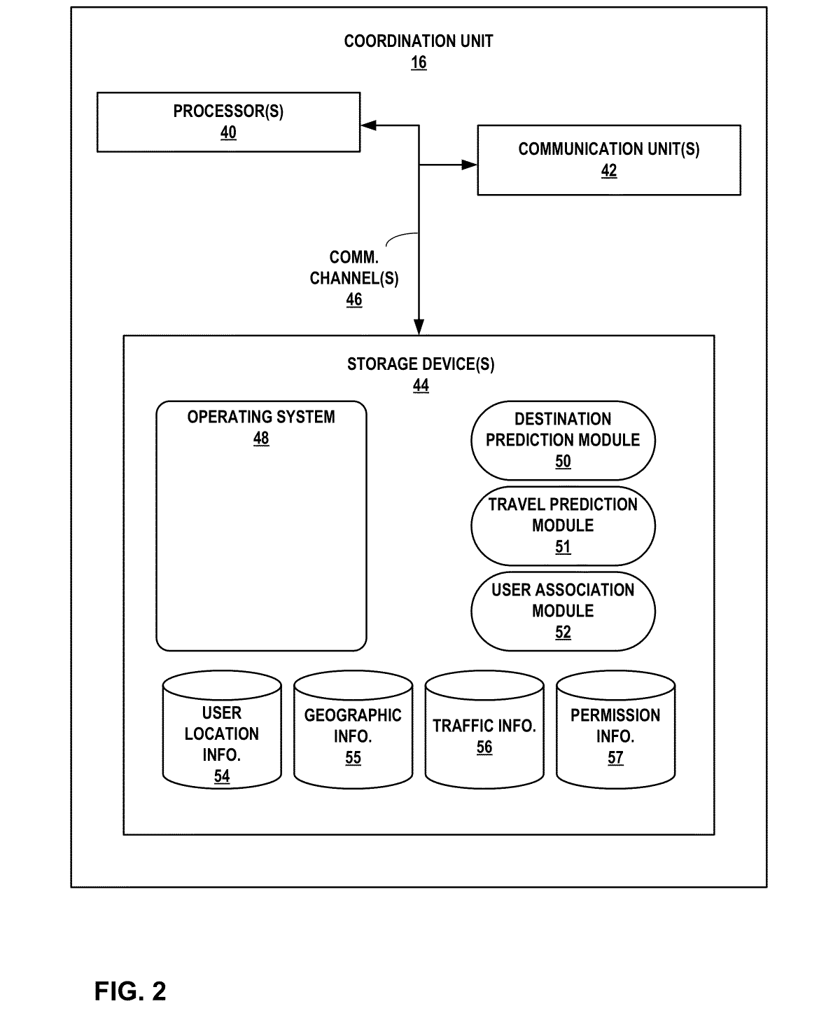

FIG. 2 is a block diagram illustrating one example of a coordination unit for providing other users with predicted travel information, in accordance with one or more aspects of the present disclosure. Coordination unit 16 may include hardware, firmware, software, or any combination thereof. In the example of FIG. 2, coordination unit 16 may comprise a hardware device, such as a server computer, having various hardware, firmware, and software components. However, FIG. 2 illustrates only one particular example of coordination unit 16, and many other examples of coordination unit 16 may be used in accordance with techniques of the present disclosure. In some examples, components of coordination unit 16 may be located in a singular location. In other examples, one or more components of coordination unit 16 may be in different locations (e.g., connected via network 10 of FIG. 1). That is, in some examples coordination unit 16 may be a conventional computing system, while in other examples, coordination unit 16 may be a distributed or “cloud” computing system.

As shown in the specific example of FIG. 2, coordination unit 16 includes one or more processors 40, one or more communications units 42, and one or more storage devices 44. Coordination unit 16 further includes operating system 48, destination prediction module 50, travel prediction module 51, and user association module 52. In the specific example of FIG. 2, coordination unit 16 also includes user location information data (USER LOCATION INFO.) 54, geographic information data (GEOGRAPHIC INFO.) 55, traffic information data (TRAFFIC INFO.) 56, and permission information data (PERMISSION INFO.) 57. In other examples, one or more of user location information data 54, geographic information data 55, traffic information data 56, and permission information data 57 may not be included in coordination unit 16. That is, in some examples, one or more of user location information data 54, geographic information data 55, traffic information data 56, and permission information data 57 may be external to, but accessible by, coordination unit 16.

Each of components 40, 42, and 44 may be interconnected (physically, communicatively, and/or operatively) for inter-component communications. In the example of FIG. 2, components 40, 42, and 44 may be coupled by one or more communications channels (COMM. CHANNELS) 46. In some examples, communications channels 46 may include a system bus, network connection, inter-process communication data structure, or any other channel for communicating data. In other examples, such as where coordination unit 16 is a distributed computing system or cloud-based computing system, communications channels 46 may include one or more network connections, such as portions of network 10 of FIG. 1. Modules 50, 51, and 52, as well as operating system 48, user location information data 54, geographic information data 55, traffic information data 56, and permission information data 57 may also communicate information with one another as well as with other components in coordination unit 16.

Processors 40, in one example, are configured to implement functionality and/or process instructions for execution within coordination unit 16. For example, processors 40 may be capable of processing instructions stored in storage devices 44. Examples of processors 40 may include, any one or more of a microprocessor, a controller, a digital signal processor (DSP), an application specific integrated circuit (ASIC), a field-programmable gate array (FPGA), or equivalent discrete or integrated logic circuitry.

Coordination unit 16, in some examples, also includes one or more communication units 42. Coordination unit 16, in one example, utilizes communication units 42 to communicate with external devices via one or more networks, such as network 10 of FIG. 1. Communication units 42 may include a network interface card, such as an Ethernet card, an optical transceiver, a radio frequency transceiver, or any other type of device that can send and receive information. Other examples of such network interfaces may include Bluetooth, 3G and WiFi radio components as well as Universal Serial Bus (USB). In some examples, coordination unit 16 utilizes communication units 42 to wirelessly communicate with one or more external devices such as computing devices 4 and/or 24 of FIG. 1, or any other computing device. For instance, communication units 42 may receive location information 12 from computing device 4, and provide location information 12 to one or more other components of coordination unit 16 (e.g., modules 50, 51, 52).

One or more storage devices 44 may be configured to store information within coordination unit 16 during operation. Storage devices 44, in some examples, can be described as a computer-readable storage medium. In some examples, storage devices 44 are a temporary memory, meaning that a primary purpose of storage devices 44 is not long-term storage. Storage devices 44, in some examples, are described as a volatile memory, meaning that storage devices 44 do not maintain stored contents when the computer is turned off. Examples of volatile memories include random access memories (RAM), dynamic random access memories (DRAM), static random access memories (SRAM), and other forms of volatile memories known in the art. In some examples, storage devices 44 are used to store program instructions for execution by processors 40. Storage devices 44, in one example, are used by software or applications running on coordination unit 16 (e.g., modules 50, 51, and 52) to temporarily store information during program execution.

Storage devices 44, in some examples, also include one or more computer-readable storage media. Storage devices 44 may be configured to store larger amounts of information than volatile memory. Storage devices 44 may further be configured for long-term storage of information. In some examples, storage devices 44 include non-volatile storage elements. Examples of such non-volatile storage elements include magnetic hard discs, optical discs, floppy discs, flash memories, or forms of electrically programmable memories (EPROM) or electrically erasable and programmable memories (EEPROM).

In some examples, coordination unit 16 may contain other components not shown in FIG. 2. For instance, coordination unit 16 may contain one or more input devices, such as devices configured to receive input from a user through tactical, audio, or video feedback, and/or one or more output devices, such as devices configured to provide output to a user using tactile, audio, or video stimuli.

In the example of FIG. 2, coordination unit 16 includes operating system 48. Operating system 48, in some examples, controls the operation of components of coordination unit 16. For example, operating system 48, in one example, facilitates the communication of modules 50, 51, and 52 with processors 40, communication units 42, and storage devices 44. Modules 50, 51, and 52 may each include program instructions and/or data that are executable by coordination unit 16. As one example, destination prediction module 50 may include instructions that cause coordination unit 16 to perform one or more of the operations and actions described in the present disclosure.

As shown in the example of FIG. 2, coordination unit 16 includes user location information data 54. User location information data 54 may be stored within storage devices 44. User location information data 54 may include information about the geographical location of one or more users in a computer-readable format. For instance, upon receiving location information 12 from computing device 4 as shown in FIG. 1, coordination unit 16 may store at least a part of location information 12 in user location information data 54. In some examples, coordination unit 16 may combine or concatenate multiple sets of location information for each user. For instance, user location information data 54 may include previously received location information from computing device 4, prior to receipt of location information 12 by coordination unit 16. In such instance, coordination unit 16 may, in some examples, add the recently received location information 12 to the previously received location information. In other examples, user location information data 54 may include a limited number of location entries (e.g., location/time pairs), such as 100, 1,000, or other value.

Coordination unit 16, in the example of FIG. 2, includes geographic information data 55. Geographic information data 55 may be stored within storage devices 44. Geographic information data 55 may include data describing features of a geographic area, such as roads, highways, structures, public transportation routes, walking trails, or other information. For instance, at least part of geographic information data 55 may be represented by a network of interconnected nodes or vertices (e.g., corresponding to street intersections, public transportation hubs, or other locations). Geographic information data 55 may, in some examples, specify the weight of each edge that exists between any two nodes. In some examples, the weight may correspond to a distance (e.g., in feet, miles, or kilometers) between to intersections. In other examples, such as where the vertices represent street intersections, the weight may be a combination of the distance and the speed limit of a road connecting the two street intersections. In other examples, geographic information data 55 may be other information, such as a matrix of “next hops” for navigating from one node to another. In other words, geographic information data 55 may be data usable by one or more components of coordination unit 16 to determine one or more travel routes.

In the example of FIG. 2, coordination unit includes traffic information data 56. Traffic information data 56 may be stored within storage devices 44. Traffic information data 56 may include data indicating traffic levels for a network of travel modalities, such as roads. Example data stored in traffic information data 56 may include data indicating a speed of traffic on a particular road or highway; data indicating congestion levels on a particular section of a roadway, data indicating an average of traffic (e.g., an average for a particular time of day) for a roadway or section of a roadway. In some examples, information stored in traffic information data 56 may be received from one or more computing devices (e.g., computing devices 4, 24 of FIG. 1). In other examples, traffic information data 56 may additionally or instead contain data received from other sources, such as a commercial or government entity providing real-time traffic data. That is, traffic information data 56 may include data from a variety of sources.

Coordination unit 16, as shown in the example of FIG. 2, includes permission information data 57. Permission information data 57 may be stored within storage devices 44. Permission information data 57 may include data indicating which other users and/or social network services are permitted to receive location information or derivative data for a particular user. That is, permission information data 57 may define the computing devices, other users, or services with which coordination unit 16 is allowed to share information of a particular user (e.g., a user of computing device 4 of FIG. 1). Coordination unit 16 may store permission information data 57 after coordination unit 16 receives permission data from a computing device of a user. For instance, after coordination unit 16 receives permission data from computing device 4 as described in FIG. 1, coordination unit 16 may store the permission data as part of permission information data 57. Thereafter, when dealing with data received from computing device 4 (or another computing device associated with a user of computing device 4), one or more components of coordination unit 16 may determine to which other users and/or social network services the data received from computing device 4 should be sent. In some examples, permission information data 57 may be time- or action-specific, such as when the user of computing device 4 authorizes coordination unit 16 to share predicted travel information with other users for a current trip only. In other examples, permission information data 57 may be persistent, allowing coordination unit 16 to share received data for a specific user until the user revokes or changes the permission that the user previously provided.

In the example of FIG. 2, coordination unit 16 includes destination prediction module 50. In some examples, destination prediction module 50 may be stored in storage devices 44 as shown in FIG. 2. In other examples, destination prediction module 50 may include hardware, firmware, software, or some combination thereof. Destination prediction module 50 may be operable or otherwise executable (e.g., by processors 40) to receive location information 12 (e.g., from communication units 42) and determine a predicted destination. In some examples, destination prediction module 50 may store a copy of location information 12 in user location information data 54 (e.g., for future use). In other examples, destination prediction module 50 may not store location information 12 for future use. In any case, in accordance with one or more techniques of the present disclosure, destination prediction module 50 may determine a predicted destination based at least in part on location information 12.

For instance, previous locations 13 may include a number of indications of computing device 4 being at a first location (e.g., a workplace) and corresponding indications of particular times of the day, such as during the workday (e.g., 8 AM-5 PM local time) for a particular weekday. Previous locations 13 may include numerous indications of computing device 4 being at a second location (e.g., a home of the user of computing device 4) and corresponding indications of other times of the day, such as during the morning (e.g., 12:00 AM-7:30 AM local time) and during the evening (5:30 PM-12:00 AM local time) of the particular weekday. Previous locations 13 may also include similar indications for a subsequent day. That is, the indications of a location and a time for the subsequent day may correspond to the second location during the morning, and the first location from then on. Current location 14 may be an indication of computing device 4 being at the first location, and a corresponding time of day near the end of the workday (e.g., 4:50 PM local time) on the subsequent day. Based on the example location information 12, coordination unit 16 may determine that the user of computing device 4 is likely to travel to his or her home, and consequently predict the second location as a travel destination.

As another example, the indication of location may indicate a location a short distance from the first location. Consequently, destination prediction module 50 may determine that the user of computing device 4 is likely already traveling to his or her home and determine the second location as a predicted destination. In other words, destination prediction module 50 may determine a predicted destination by analyzing the indications of locations and indications of times included in location information 12 and determining that it is statistically likely that the computing device will be located at the predicted destination in the near future.

Destination prediction module 50 may, in various examples, be operable to determine a predicted destination in a number of ways, such as reviewing previous communications of the user, reviewing location information received from other users (e.g., aggregating location information), or other ways. For instance, destination prediction module 50 may receive explicit permission from a user of computing device 4 (e.g., entered at computing device 4) to access, review, and/or monitor email information, telephone call information, text message information, application information, or other information in order to predict travel destinations. Destination prediction module 50 may then analyze the received information to determine a predicted destination.

In one example, destination prediction module 50 may receive text message information indicating that the user of computing device 4 recently received a message indicating a specific location, such as “Hey, we′re at the pub on 5th street. You should come!” The received text message data may also indicate that the user of computing device 4 sent a response to the message, such as “I will be there soon, I am leaving now.” Responsive to analyzing the received text message information, destination prediction module 50 may determine that there is a high probability that the user (and thus computing device 4) is headed to a “pub on 5th street” in the near future, and may attempt to locate the specific pub (e.g., by accessing geographic info 55). Destination prediction module 50 may utilize combinations of various types of information (e.g., location information 12 and text message information) to determine a predicted destination of the user. In some examples, after determining a predicted destination, destination prediction module 50 may send the predicted destination to one or more other components of coordination unit 16, such as travel prediction module 51 and/or user association module 52.

Coordination unit 16, in the example of FIG. 2, includes travel prediction module 51. In some examples, travel prediction module 51 may be stored in storage devices 44 as shown in FIG. 2. In other examples, travel prediction module 51 may include hardware, firmware, software, or some combination thereof. Travel prediction module 51 may be operable or otherwise executable (e.g., by processors 40) to receive a predicted destination from destination prediction module 50 and determine a predicted travel route of the user (e.g., the user of computing device 4).

After receiving the predicted destination, travel prediction module 51 may access geographic information data 55 and retrieve geographical data (e.g., defining roads) in order to determine the predicted travel route. The determined predicted travel route may be based at least in part on current location 14. That is, travel prediction module 51 may use geographic information data 55 to determine a route on which the user of computing device 4 is most likely to travel, from the location indicated by current location 14, to reach the predicted destination. The predicted travel route may include information defining roads upon which the user will likely drive, public transportation routes the user will likely take, walking paths the user will likely use, bicycle paths the user will likely use, or other methods of travel. In some examples, travel prediction module 51 may utilize traffic information data 56 in addition to geographic information data 55. For instance, if the user of computing device 4 is traveling by motor vehicle, travel prediction module 51 may utilize traffic information data 56 to determine the most efficient roads (e.g., as defined by geographic information data 55) for the user to travel on.

In some examples, coordination system 16 may receive an indication of a mode of travel (e.g., walking, biking, public transit, or other mode of travel) from a user. In other examples, coordination unit 16 may use a default mode of travel, or may determine the user's mode of travel. For instance, when the indications of locations included in location information 12 are sufficiently spread out, travel prediction module 51 may determine that the user of computing device 4 is likely traveling by motor vehicle. In another example, after explicitly receiving permission from the user of computing device 4 to access accelerometer data of computing device 4, coordination unit 16 may receive an indication of accelerometer data. Based at least in part on the received accelerometer data, travel prediction module 51 may determine that the user of computing device 4 is traveling by bicycle.

After determining a predicted travel route for a user, travel prediction module 51 may determine a predicted arrival time indicating when the user will likely arrive at the predicted destination. In some examples, travel prediction module 51 may access traffic information data 56 and retrieve data in order to determine a predicted speed at which the user of computing device 4 will likely travel along the predicted travel route. For instance, when the user of computing device 4 is traveling by automobile, travel prediction module 51 may use traffic information data 56 to determine how quickly the user of computing device 4 will travel on each segment of roadway defined in the predicted travel route. Travel prediction module 51 may use the determined speeds to determine a total travel time. The total travel time may represent the time it takes for a user to get from the location indicated by current destination 14 to the predicted destination. In some examples, the predicted arrival time may be a duration of time, such as the total travel time. That is, the predicted arrival time may be the time that it will take for a user (e.g., the user of computing device 4) to travel from his or her current location to the predicted destination using the predicted travel route. In other examples, the predicted arrival time may be a time value, such as the time of day at which the user is predicted to arrive. In this instance, travel prediction module 51 may use the indication of the current time (e.g., included in current location 14), and add on the total travel time. In either case, after determining the predicted arrival time, travel prediction module 51 may send at least one of the predicted destination, the predicted travel route, and the predicted destination to one or more other components of coordination unit 16, such as user association module 52.

In the example of FIG. 2, coordination unit 16 includes user association module 52. In some examples, user association module 52 may be stored in storage devices 44 as shown in FIG. 2. In other examples, user association module 52 may include hardware, firmware, software, or some combination thereof. User association module 52 may be operable or otherwise executable (e.g., by processors 40) to determine one or more other users, in accordance with one or more techniques of the present disclosure.

User association module 52 may receive an indication of a predicted destination from destination prediction module 50 and indications of a predicted travel route, a predicted mode of travel, and/or a predicted arrival time from travel prediction module 51. Responsive to receiving the indication of the predicted destination, user association module 52 may determine one or more other users or social network services with which to share the received information. In some examples, user association module 52 may access user location information data 54 to determine the one or more other users. That is, user association module may define the one or more other users as those users associated with the predicted destination. As described above, user location information data 54 may only contain location information for those users who explicitly indicated to have his or her respective computing device send location information to coordination unit 16. In some examples, user association module 52 may search user location information data 54 and retrieve other users associated with a current location corresponding to the predicted destination. In other examples, user association module 52 may also retrieve users that are associated with a past location that corresponds to the predicted destination. User association module 52 may restrict the results to users associated with past locations that correspond to a certain amount of time, such as within the past 30 minutes, within the past 2 hours, or the like.

In other examples, user association module 52 may access permission information data 57 to determine the one or more other users and/or one or more social network services. In other words, user association module 52 may determine the one or more other users as those users or social network services associated with the user, or with which the user (e.g., the user of computing device 4) has permitted coordination unit 16 to share information. For instance, permission information data 57 may include permission information specifying that the user of computing device 4 has explicitly allowed coordination unit 16 to share location information and/or derivative information with another user (e.g., the user of computing device 24). User association module 52 may retrieve this information, and consequently specify the user of computing device 24 as “associated” with the user of computing device 4 for purposes of sharing location information and/or derivative information. In some examples, user association module 52 may specify the user of computing device 24 as an “associated” user only for the purposes of a specific destination, a specific time of day, or a specific level of activities (e.g., only for business travel of the user of computing device 4). In other examples, user association module 52 may specify the user of computing device 24 as an associated user indefinitely (e.g., unless and until the user of computing device 4 revokes the permission). In some examples, user association module 52 or other components of coordination unit 16 may proactively suggest other users with whom the user of computing device 4 might want to share information. Suggestions may be based on an analysis of how often the other users communicate with the user of computing device 4, how similar the users' location history is, or a combination thereof.

In yet other examples, user association module 52 may determine the one or more other users based on other information received from computing device 4 and/or computing device 24, such as one or more of accelerometer data, location data, calendar data, communication data, traffic data, or flight information data. For instance, coordination unit 16 may receive explicit permission from the user of computing device 4 to access previous communications of the user, such as email communications, text message communications, phone call communications, or other communications. User association module 52 may be operable to access the previous communications and search or “mine” the communications for keywords, such as location key words, user relationship keywords, or other types of keywords. In some examples, user association module 52 may identify keywords that correspond to the predicted destination (e.g., the name of a landmark, the name of a restaurant or store, an address, etc.). Based on the determined keywords, user association module 52 may determine a subset of the previous communications that include at least one of the identified keywords. User association module 52 may then determine the one or more users based at least in part on the subset of previous communications. For instance, user association module 52 may determine the one or more users to include all contacts with whom the subset of previous communications were exchanged.

In any case, after determining the one or more other users and/or social networks with which coordination unit 16 is authorized to share information, user association module 52 may cause coordination unit 16 (e.g., via communication units 42) to send an indication of the predicted arrival time to one or more computing devices associated with the one or more other users. In some examples, coordination unit 16 may cause the one or more computing devices associated with the one or more other users to proactively display predicted travel information of the user of computing device 4. In other examples, the one or more computing devices may receive the information, but may only display the information in response to a request from a respective user of the computing devices. In some examples, coordination unit 16 may only send indications of a predicted arrival time of a user after coordination unit 16 has determined a predicted destination of the user and before coordination unit 16 determines that the user has arrived at the destination.

In this way, coordination unit 16 may allow other users to receive and/or view the predicted travel information during the time periods in which the user is most likely to travel, such as when the user is commuting from home to work and/or from work to home. That is, coordination unit 16 may enable users to inform other users of current travels and other contextual information without having to send messages, post social network status message updates, or otherwise manually inform the other users. Instead, after a user explicitly allows coordination unit 16 to share contextual information with the other users, coordination unit 16 may receive information from a computing device of the user, determine a context of the user (e.g., location, activity, availability, or the like), and automatically provide an indication of the context to the other users, social network services, or other entities.

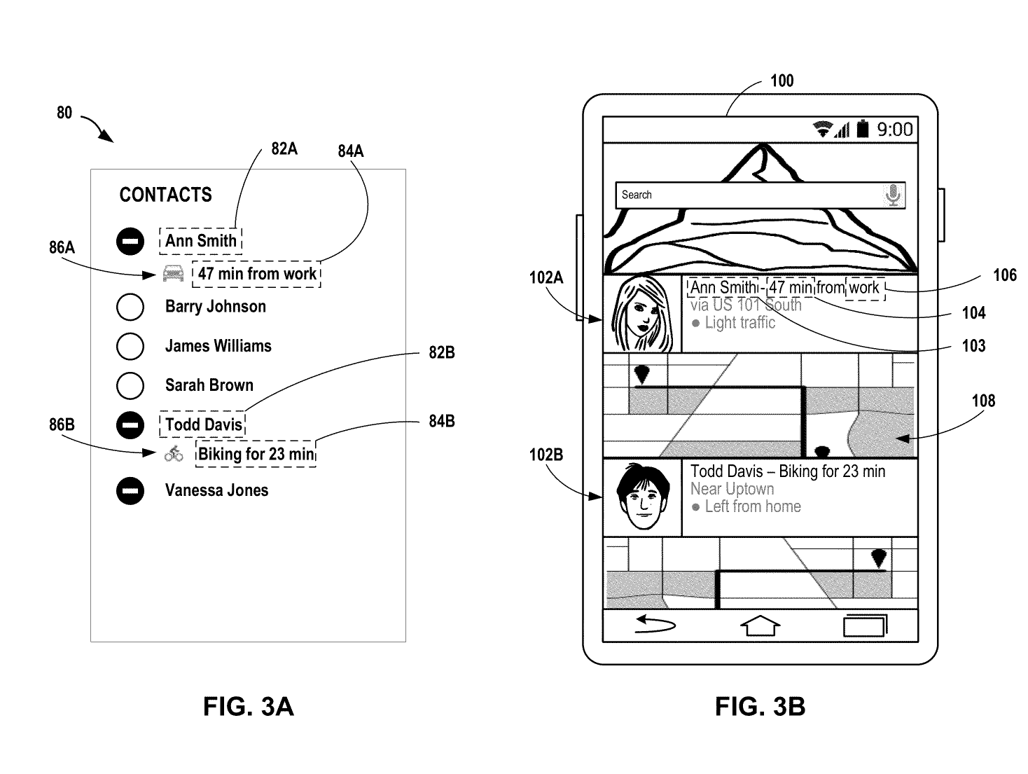

FIGS. 3A and 3B are conceptual diagrams illustrating example GUIs for providing other users with predicted travel information, in accordance with one or more aspects of the present disclosure. FIGS. 3A and 3B are described below within the context of computing device 24 from FIG. 1. In various examples, FIGS. 3A and 3B may be output by one or more components of computing device 24 for display at the display of a remote computing device, at an external display device, and/or at an internal display device of computing device 24 (e.g., user interface device 26). FIGS. 3A and 3B include GUIs that may be displayed only to users authorized to receive such information.

FIG. 3A includes an example GUI 80 that displays social network service status messages to other users. GUI 80 includes usernames 82A and 82B (collectively “usernames 82”), user status indicators 84A and 84B (collectively “user status indicators 84”), and travel mode indicators 86A and 86B (collectively “travel mode indicators 86”). GUI 80 may represent a list of users of a social network service, and associated status messages. For instance, username 82A may correspond to a social network account for a user of computing device 4. In accordance with techniques of the present disclosure, computing device 4 may send location information 12 to coordination unit 16. Coordination unit 16 may determine predicted travel information (e.g., a predicted destination, a predicted travel route, a predicted arrival time, and the like), and output an indication of at least the predicted arrival time and user identification information to a social network service (e.g., computing device 24). Computing device 24 may receive the indication and update a status message of the social network account associated with the user. Thereafter, responsive to a request from another user, computing device 24 may output GUI 80 for display at a computing device of the other user. In some examples, GUI 80 may only be a portion or particular region of a larger GUI.

In the example of FIG. 3A, GUI 80 includes usernames 82. Each of usernames 82 may show a username corresponding to a social network account associated with a user of a computing device. For instance, username 82A, displaying “Ann Smith,” may correspond to a social network account of a user of computing device 4. In some examples, usernames 82 may display actual names of the users. In other examples, usernames 82 may display names set by a user viewing GUI 80 (e.g., nicknames), names set by users associated with the displayed social network accounts (e.g., the user of computing device 4), or other information.

GUI 80, in the example of FIG. 3A, includes user status indicators 84. User status indicators 84 may each be associated with respective username indicators 82. In accordance with techniques of the present disclosure, user status indicators 84 may display the current contextual status of a user associated with the corresponding social network account. For instance, computing device 24 may receive an indication of predicted travel information of the user of computing device 4, and may modify a status message displayed in user status indicator 84A to include at least a part of the predicted travel information. As shown in GUI 80, user status indicator 84A includes the text “47 min from work.” The included text may be generated by computing device 24 based at least in part on an indication of predicted travel information (or other context information) received from coordination unit 16. That is, user status indicator 84A includes the predicted destination, “work,” as well as the predicted arrival time, “47 min.” In some examples, user status indicators may include other predicted contextual information, such as a predicted mode of travel, a predicted current duration of travel, a predicted activity, a predicted availability, a predicted destination, or other predicted information. For instance, user status indicator 84B includes a predicted mode of travel, stating that the user associated with a social network account having the username displayed in username indicator 82B (e.g., “Todd Davis”) is “biking” That is, coordination unit 16 may have analyzed various types of information received from computing device 4 (e.g., accelerometer information, location information, calendar information, or other information), and determined that the user is likely riding a bike. Coordination unit 16 may send an indication of the predicted mode of travel to computing device 24. Consequently, computing device 24 may output user status indicator 84B. User status indicator 84B also includes a duration, “23 min.”

In some examples, coordination unit 16 may be unable to determine a predicted destination for a user. In the event that coordination unit 16 is unable to determine a predicted destination, coordination unit 16 may instead output a duration of the present activity. In other words, in some examples, instead of displaying when the user is going to be available or where the user will be, coordination unit 16 may output information indicating how long the user has been unavailable and/or what the user is currently doing.

In the example of FIG. 3A, GUI 80 includes travel mode indicators 86. Travel mode indicators 86 may be instead of, or in addition to the predicted mode of travel being included in user status indicators 84. For instance, travel mode indicator 86A displays a car icon, showing that coordination unit 16 determined an automobile as a predicted mode of travel for the user of computing device 4, while travel mode indicator 86B displays a bicycle icon, indicating that coordination unit 16 determined a bicycle as a predicted mode of travel for the user associated with the social network account displayed in username indicator 82B.

In some examples, coordination unit 16 may receive subsequent location information from a computing device of a user associated with the social network account having username 82A. Based on the subsequent location information, coordination unit 16 may determine that the user (e.g., the user of computing device 4) has reached the predicted destination or has otherwise ceased traveling. For instance, the subsequent location information may include an indication of a current location of computing device 4 that is at or substantially close to the predicted destination (e.g., a workplace of the user). Responsive to determining that the user is at the predicted destination, coordination unit 16 may send an indication to computing device 24. The indication may cause computing device 24 to modify the status message displayed in user status indicator 84A to exclude the predicted travel information. In some examples, computing device 24 may modify the status message by reverting the message to a previous status message. In other examples, computing device 24 may modify the status message in other ways, such as indicating the current location of the user.

Various other examples of contextual information may be displayed as part of or in addition to social network status messages, such as a current location of a user, a predicted travel route of the user, a scheduled appointment (e.g., a meeting) in which the user is included in, an activity (e.g., “working out”) in which the user is currently engaging, or other contextual information. GUI 80 is only one example GUI for displaying social network status message updates to other users, and various other example GUIs may be used.

FIG. 3B illustrates an example GUI 100 for providing other users with predicted travel information. For instance, GUI 100 may be displayed at UI device 26 of computing device 24, or at one or more other computing devices associated with one or more other users. As shown in FIG. 3B, GUI 100 includes cards 102A and 102B (collectively “cards 102”). Card 102A includes username 103, predicted arrival time 104, predicted destination 106 and map 108. In some examples, each of cards 102 may only be displayed when coordination unit 16 has determined that the user associated with the information displayed on the card is traveling. That is, coordination unit 16 may have determined that the user “Ann Smith” and the user “Todd Davis” are both currently traveling.

As shown in the example of FIG. 3B, card 102A includes username 103. Username 103 may indicate the user whose information is included in the card. Examples of username 103 may include the user's name, the user's phone number, or other identification of the user (e.g., an ID number or alias). Username 103 may be similar to usernames 82 as shown in FIG. 3A.

Card 102A, as shown in the example of FIG. 3B, includes predicted arrival time 104 and predicted destination 106. Predicted arrival time 104 may display the predicted arrival time of the relevant user, as determined by coordination unit 16. Predicted arrival time 104 may be displayed as a duration of time (e.g., number of minutes), as shown in FIG. 3B, or may be displayed as a specific time (e.g., time of day). Predicted arrival time 104, as shown in FIG. 3B, may be periodically updated. For instance, coordination unit 16 may receive subsequent location information from computing device 4, indication a subsequent current location of computing device 4. Based at least in part on the subsequent location information, coordination unit 16 may determine subsequent predicted travel information, such as a subsequent predicted arrival time, a subsequent predicted travel route, and other information. Coordination unit 16 may send an indication of at least the subsequent predicted arrival time to computing device 24, and computing device 24 may update predicted arrival time 104 of card 102A.

In the example of FIG. 3B, card 102A includes predicted destination 106. Predicted destination 106 may display the predicted destination of the user, as determined by coordination unit 16. In some examples, predicted destination 106 may indicate a user-specific destination. That is, the displayed destination may be a reference to an address, a place, or other location which relates to the user in some way. For instance, as shown in the example of FIG. 3B, predicted destination 106 is displayed as “work.” The displayed predicted destination may be a workplace of the user of computing device 4. Other examples of user-specific destinations include a home of the user, a favorite restaurant of the user, a gym or workout facility of the user, or other destinations. In some examples, predicted destination 106 may include absolute destinations, such as an address, a business name, or geographical coordinates.

Card 102A, in the example of FIG. 3B, includes map 108. Map 108 may be a graphical representation of predicted travel information determined by coordination unit 16. For example, map 108 may include a predicted destination of the user (e.g., as shown in predicted destination 106), a predicted travel route of the user, or other information. In some examples, cards may not include a map, such as where display area is limited, or where a user does not explicitly authorize coordination unit 16 to share such information.

By allowing other users to view the predicted travel information of a user without the user having to manually enter such information, techniques of the present disclosure may make it easier for people to coordinate travel plans, and stay up-to-date on the status and context of close friends and family. Coordination unit 16, by providing an indication of predicted travel information to other users, social network services, or both, may decrease the need for a user to manually communicate regarding when the user will arrive at a destination, where the user is currently headed, how the user is getting there, and other travel-related information. In some examples, coordination unit 16 may also provide other users or social network services with various other information about the user's current context, thereby potentially reducing the number of interruptions the user may receive during activities.

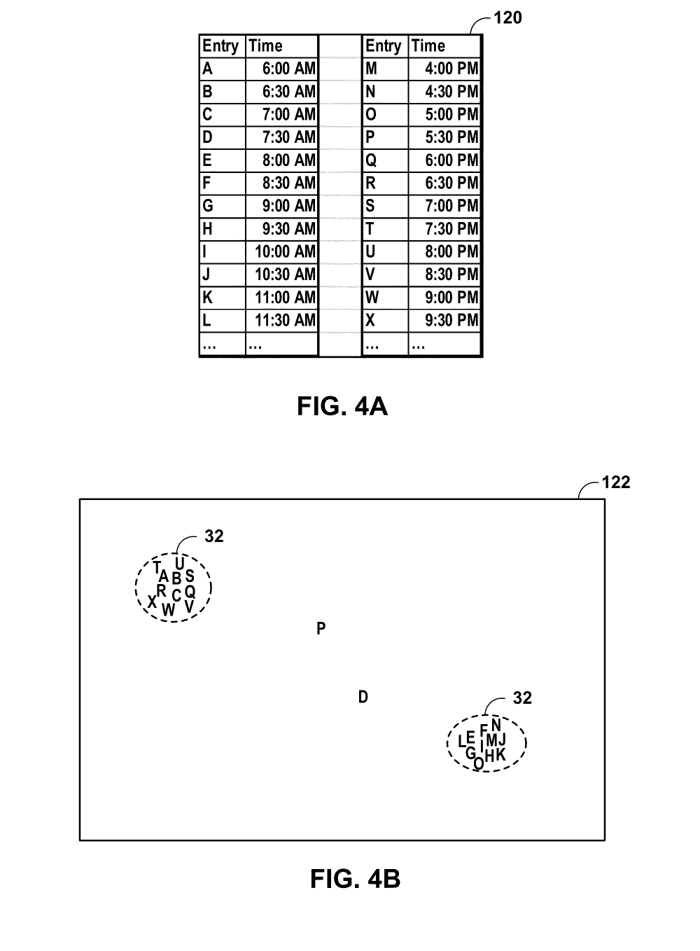

FIGS. 4A and 4B are conceptual diagrams illustrating example location information for providing other users with predicted travel information, in accordance with one or more aspects of the present disclosure. For purposes of understanding only, FIGS. 4A and 4B are described within the context of FIGS. 1 and 2. FIG. 4A may include table 120 representing data indicating locations of computing device 4 as well as associated times. FIG. 4B includes a graphical depiction of the locations included in table 120.

Table 120 of FIG. 4A may represent location information 12, as received by coordination unit 16. Each row of table 120 may represent a past location or current location of computing device 4 and a time at which the location was determined. For instance, the first row of table 120 shows that at 6:00 AM (e.g., local time), computing device 4 was located at location “A.” At 6:00 AM, computing device 4 was located at location “B,” and so on. Each of the letters shown in the “Entry” column of table 120 (e.g., “A,” “B,” “C,” and so on) may represent geographic location information, such as GPS data, latitude/longitude coordinate pairs, or other data for specifying a particular geographic location. That is, while shown in FIG. 4A as a letter, each row of table 120 may include geographical data in the “Entry” column. In some examples, table 120 may contain more or different information. For instance, while table 120 only includes locations determined every half hour, location information 12 may include locations determined at a different rate, such as every 10 minutes, every minute, or other rate.

FIG. 4B includes a geographical representation (e.g., map 122) of the information displayed in table 120 of FIG. 4A. That is, map 122 shows each of the location entries shown in table 120. As seen in FIG. 4B, each of locations “A,” “B,” “C,” “Q,” “R,” “S,” “T,” “U,” “V,” “W,” and “X,” are substantially close to one another in the upper left portion of map 122. Each of locations “E,” “F,” “G,” “H,” “I,” “J,” “K,” “L,” “M,” “N,” and “O,” are substantially close to one another in the lower right portion of map 122. Location “P” and location “D” are not located substantially close to each other, or to any other locations.

Table 120 and map 122 may include entries only for a single day, such as a Monday. In some examples, location information 12 may also include entries for other days, such as location information for the subsequent Tuesday, Wednesday, and Thursday. Locations determined for Tuesday, Wednesday, and Thursday may substantially correspond to those shown in table 120 and map 122 for Monday. That is, table 120 shows that at 5:00 PM on Monday, computing device 4 was located at location “O” on map 122. Though not shown, location information 12 may also include an indication that at 5:00 PM on Tuesday, computing device 4 was located at or near location “O.”

Coordination unit 16, in some examples, may determine a predicted destination for the user of computing device 4 by analyzing location information 12. Based on location information 12, coordination unit 16 may determine one or more location patterns, such as a daily pattern, a weekly pattern, or other pattern. In the example of FIGS. 4A and 4B, coordination unit 16 may determine a daily pattern based on the fact that the location of computing device 4 is substantially the same each day at substantially the same time.

Based on the determined patterns, coordination unit 16 may determine at least two sets of indications included in previous locations 13, such that each indication in a set of indications corresponds to substantially the same location. For instance, coordination unit 16 may determine a first set of indications that includes locations “A,” “B,” “C,” “Q,” “R,” “S,” “T,” “U,” “V,” “W,” and “X,” and a second set of indications that includes locations “E,” “F,” “G,” “H,” “I,” “J,” “K,” “L,” “M,” “N,” and “O.” When determining the sets of indications, coordination unit 16 may determine a set based on various criteria, such as the distance of each indicated location from the other indicated locations and/or the time between the indications. For example, coordination unit 16 may only consider two indicated locations to be “substantially the same” when the indicated locations are less than 100 yards apart. In other examples, “substantially the same” may be based on other distances, such as one mile, fifty feet, ten feet, or other distance. In some examples, coordination unit 16 may also utilize geographic data, or other information to determine the sets of indications.

For each set of indications, coordination unit 16 may determine a corresponding or average location. That is, coordination unit may predict a single location that represents each of the indicated locations in the set. In some examples, the determined average locations may be based on the times associated with each indication. In other examples, the determined average locations may be based on other information, such as geographical information. Continuing with the example location information from Monday, Tuesday, Wednesday, and Thursday, coordination unit 16 may determine a first location (e.g., a home) corresponding to the first set of indications, and a second location (e.g., a workplace) corresponding to the second set of indications.

Coordination unit 16, in some examples, may determine a predicted destination based at least in part on the determined average locations and the times at which computing device 4 was located near the average locations. For instance, coordination unit 16 may receive location information 12 on Thursday, just after 5:00 PM local time. After analyzing the indications of location, coordination unit 16 may have determined a home location and a work location. Current location 14 may correspond to the second (e.g., workplace) location, while the determined daily pattern shows that computing device 4 should soon be located at the first (home) location. In this way, coordination unit 16 may determine that the user of computing device 4 is likely to travel home, to the first location in the near future, and use the first location as a predicted location for the user in accordance with the techniques of the present disclosure.

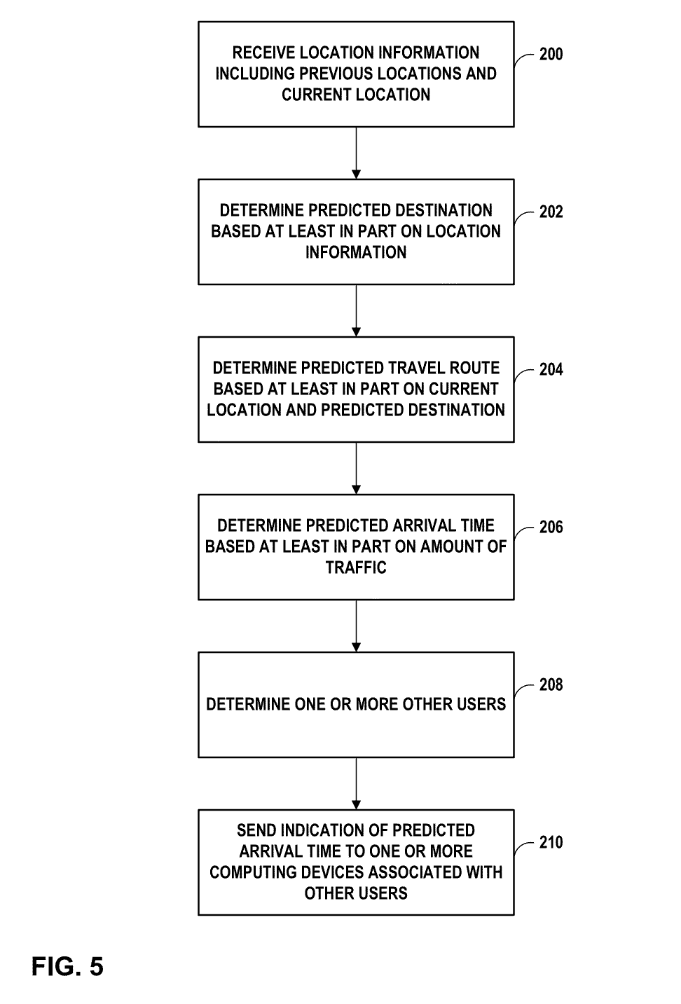

FIG. 5 is a flow diagram illustrating example operations for providing other users with predicted travel information, in accordance with one or more aspects of the present disclosure. For purposes of illustration only, the example operations of FIG. 5 are described below within the context of coordination unit 16 as shown in FIGS. 1 and 2.

In the example of FIG. 5, communication unit 16 may receive location information associated with a computing device (200). In some examples, the location information may include a plurality of indications of locations at which the computing device was previously located and an indication of a current location of the computing device. In some examples, the computing device is associated with a user. Communication unit 16 may determine a predicted destination of the user, based at least in part on the location information (202). Based at least in part on the current location of the computing device and the predicted destination, communication unit 16 may determine a predicted travel route of the user to the predicted destination (204).

Communication unit 16 may, based at least in part on an amount of traffic along the predicted travel route, determine a predicted arrival time of the user at the predicted destination (206). Communication unit 16 may determine one or more other users associated with the user, based at least in part on the predicted destination (208). Communication unit 16 may send, to one or more computing devices associated with the one or more other users, an indication of the predicted arrival time of the user.

In one example, the operations further include determining, by the computing system and based at least in part on the location information, a predicted mode of travel of the user, wherein determining the predicted travel route is further based at least in part upon the predicted mode of travel. In one example, the operations further include sending, by the computing system and to the one or more computing devices associated with the one or more other users, an indication of the predicted mode of travel of the user. In one example, determining the predicted destination includes determining a first set of indications from the plurality of indications of locations at which the computing device was previously located, wherein the first set of indications indicate respective locations corresponding to a first location, determining a second set of indications from the plurality of indications of locations at which the computing device was previous located, wherein the second set of indications indicate respective locations corresponding to a second location, and responsive to determining that the current location of the computing device corresponds to the first location, determining that the second location is the predicted destination.

In one example, the operations further include receiving, by the computing system, an indication of a subsequent location of the computing device, determining, by the computing system, that the subsequent location corresponds to the predicted destination, and sending, by the computing system and to the one or more computing devices associated with the one or more other users, a notification that the user arrived at the predicted destination. In one example, the computing device is a first computing device and the user is a first user, and the operations further include receiving, by the computing system, an indication of a current location of a second computing device, wherein the second computing device is associated with a second user included in the one or more other users, determining, by the computing system and based at least in part on the current location of the second computing device, a predicted arrival time of the second user, and, responsive to determining that the predicted arrival time of the second user is approximately equal to or greater than the predicted arrival time of the first user, sending, by the computing system and to the second computing device, a notification that the second user should depart.

In one example, the operations further include sending, by the computing system and to a social network service, instructions to cause the social network service to modify a social network status message associated with the user to include at least the predicted arrival time. In one example, the operations further include receiving, by the computing system, an indication of a subsequent location of the computing device and responsive to determining that the subsequent location corresponds to the predicted destination, sending, by the computing system and to the social network service, instructions to cause the social network service to modify the social network status message associated with the user to exclude at least the predicted arrival time. In some examples, the operations further include receiving, by the computing system, indications of subsequent locations of the computing device, determining, by the computing system and based at least in part on the subsequent locations, an updated predicted arrival time of the user at the predicted destination, and periodically sending, by the computing system and to the one or more computing devices associated with the one or more other users, an indication of the updated predicted arrival time.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
determining, by a computing system and based at least in part on location information associated with a first computing device, a predicted destination, wherein the first computing device is associated with a first user;
determining, by the computing system, a predicted arrival time of the first user at the predicted destination;
determining, by the computing system and based at least in part on the predicted destination, a second user who is associated with the first user;
determining, by the computing system and based at least in part on a current location of a second computing device, a predicted arrival time of the second user at the predicted destination, wherein the second computing device is associated with the second user;
responsive to determining that a difference between the predicted arrival time of the first user and the predicted arrival time of the second user satisfies a condition that is based on a threshold duration of time, sending, by the computing system and to the second computing device, an indication instructing the second user to depart from the current location of the second computing device; and
responsive to determining that the difference does not satisfy the condition, refraining from sending, by the computing system, the indication instructing the second user to depart from the current location of the second computing device.

2. The method of claim 1, further comprising determining, by the computing system and based at least in part on the location information associated with the first computing device, a predicted mode of travel of the first user, wherein determining the predicted arrival time of the first user is further based at least in part upon the predicted mode of travel of the first user.

3. The method of claim 2, further comprising sending, by the computing system and to the second computing device, an indication of the predicted mode of travel of the first user.

4. The method of claim 1, wherein determining the predicted destination comprises:
determining, based at least in part on the location information associated with the first computing device, a first set of locations at which the first computing device was previously located, wherein each of the first set of locations corresponds to a first geographical location;
determining, based at least in part on the location information associated with the first computing device, a second set of locations at which the first computing device was previous previously located, wherein each of the second set of locations corresponds to a second geographical location; and
responsive to determining that a current location of the first computing device corresponds to the first geographical location, determining that the second geographical location is the predicted destination of the first user.

5. (canceled)

6. The method of claim 1, further comprising:
sending, by the computing system and to a social network service, instructions to cause the social network service to modify a social network status message associated with the first user to include at least the predicted arrival time of the first user.

7. The method of claim 6, further comprising:
responsive to determining, based at least in part on the location information associated with the first computing device, that the first user has arrived at the predicted destination, sending, by the computing system and to the social network service, instructions to cause the social network service to modify the social network status message associated with the first user to exclude at least the predicted arrival time of the first user.

8. (canceled)

9. A computing system comprising:
at least one processor; and
at least one module operable by the at least one processor to:
determine, based at least in part on location information associated with a first computing device, a predicted destination, wherein the first computing device is associated with a first user;
determine a predicted arrival time of the first user at the predicted destination;
determine, based at least in part on the predicted destination, a second user who is associated with the predicted destination;
determine, based at least in part on a current location of a second computing device, a predicted arrival time of the second user at the predicted destination, wherein the second computing device is associated with the second user;
responsive to determining that a difference between the predicted arrival time of the first user and the predicted arrival time of the second user satisfies a condition that is based on a threshold duration of time, send, to the second computing device, an indication instructing the second user to depart from the current location of the second computing device; and
responsive to determining that the difference does not satisfy the condition, refrain from sending the indication instructing the second user to depart from the current location of the second computing device.

10. The system of claim 9, wherein the at least one module is further operable by the at least one processor to determine, based at least in part on the location information associated with the first computing device, a predicted mode of travel of the first user, and wherein determining the predicted arrival time of the first user is further based at least in part upon the predicted mode of travel of the first user.

11. The system of claim 10, wherein the at least one module is further operable by the at least one processor to send, to the second computing device, an indication of the predicted mode of travel of the first user.

12. The system of claim 9, wherein the at least one module is further operable by the at least one processor to:
determine, based at least in part on the location information associated with the first computing device, a first set of locations at which the first computing device was previously located, wherein each of the first set of locations corresponds to a first geographical location;
determine, based at least in part on the location information associated with the first computing device, a second set of locations at which the first computing device was previously located, wherein each of the second set of locations corresponds to a second geographical location; and
responsive to determining that a current location of the first computing device corresponds to the first geographical location, determining that the second geographical location is the predicted destination of the first user.

13. The system of claim 9, wherein the at least one module is further operable by the at least one processor to:
responsive to determining, based at least in part on the location information associated with the first computing device, that the first user has arrived at the predicted destination, send, to the second computing device, a notification that the first user arrived at the predicted destination.

14. The system of claim 9, wherein the at least one module is further operable by the at least one processor to:
send, to a social network service, instructions to cause the social network service to modify a social network status message associated with the first user to include at least the predicted arrival time of the first user.

15. The system of claim 14, wherein the at least one module is further operable by the at least one processor to:
responsive to determining, based at least in part on the location information associated with the first computing device, that the first user has arrived at the predicted destination, send, to the social network service, instructions to cause the social network service to modify the social network status message associated with the first user to exclude at least the predicted arrival time of the first user.

16. (canceled)

17. A computer-readable storage medium encoded with instructions that, when executed, cause at least one processor of a computing system to:
determine, based at least in part on location information associated with a first computing device, a predicted destination, wherein the first computing device is associated with a first user;
determine a predicted arrival time of the first user at the predicted destination;
determine, based at least in part on previous communications of the first user, a second user who is associated with the previous communications;
determine, based at least in part on a current location of a second computing device, a predicted arrival time of the second user at the predicted destination, wherein the second computing device is associated with the second user;
responsive to determining that a difference between the predicted arrival time of the first user and the predicted arrival time of the second user satisfies a condition that is based on a threshold duration of time, send, to the second computing device, an indication instructing the second user to depart from the current location of the second computing device; and
responsive to determining that the difference does not satisfy the condition, refrain from sending the indication instructing the second user to depart from the current location of the second computing device.

18. The computer-readable storage medium of claim 17, further encoded with instructions that, when executed, cause the at least one processor to:
data mine the previous communications of the first user for one or more keywords;
identify at least one of the one or more keywords that corresponds to the predicted destination of the first user;
determine a subset of the previous communications of the first user that each include the at least one identified keyword; and
determine, based at least in part on the subset of previous communications of the first user, the second user.

19. The computer-readable storage medium of claim 17, further encoded with instructions that, when executed, cause the at least one processor to:
determine, based at least in part on the location information associated with the first computing device, a first set of locations at which the first computing device was previously located, wherein each of the first set of locations corresponds to a first geographical location;
determine, based at least in part on the location information associated with the first computing device, a second set of locations at which the first computing device was previously located, wherein each of the second set of locations corresponds to a second geographical location; and
responsive to determining that a current location of the first computing device corresponds to the first geographical location, determine that the second geographical location is the predicted destination of the first user.

20. The computer-readable storage medium of claim 17, further encoded with instructions that, when executed, cause the at least one processor to:
send, to a social network service, instructions to cause the social network service to modify a social network status message associated with the first user to include at least the predicted arrival time of the first user.

21. The method of claim 1, further comprising:
responsive to determining, by the computing system and based at least in part on the location information associated with the first computing device, that the first user has arrived at the predicted destination, determining whether the second user is at the predicted destination; and
responsive to determining that the second computing device is at not at the predicted destination, sending, by the computing system and to the second computing system, an indication informing the second user that the first user has arrived at the predicted destination.

22. The method of claim 1, wherein determining the second user who is associated with the first user comprises determining the second user based at least in part on location information associated with the second computing device.

23. The method of claim 1, wherein the computing system comprises the first computing device.
